(19) United States
(12) Patent Application Publication
(10) Pub. No.: US 2026/0246905 A1
(43) Pub. Date: Aug. 20, 2026

(54) STEREOSCOPIC DISPLAY BASED ON OUT OF PHASE IMAGE PROCESSING

(71) Applicant: APPLE INC., Cupertino, CA (US)

(72) Inventors: David R. Pope, Campbell, CA (US); D. Amnon Silverstein, Palo Alto, CA (US)

(73) Assignee: APPLE INC., Cupertino, CA (US)

(21) Appl. No.: 19/057,745

(22) Filed: Feb. 19, 2025

(51) Int. Cl. H04N 13/167; H04N 13/344

(52) U.S. Cl. CPC H04N 13/167; H04N 13/344

(57) ABSTRACT

Disclosed herein are a system, method, and computer program product embodiments for capturing and displaying image frames out of phase by, for example, utilizing a single ISP. For instance, the processing and displaying of a first image frame for a first eye and a second image frame for a second eye are performed out of phase. Each image sensor may readout its image at different times. While one image sensor is reading out pixels of a first image frame, the other image sensor exposes a second image frame. The single ISP may process the pixels of the image frame as they are read out by the image sensor. The single ISP may process these pixels as they are received from the image sensor, process the pixels for presentation, and provide the pixels to the corresponding display. The displays display the first and second image frame out of phase.

### BACKGROUND

Virtual reality (VR) allows users to experience and/or interact with an immersive artificial environment, such that the user feels as if they were physically in that environment. For example, virtual reality systems may display stereoscopic scenes to users in order to create an illusion of depth. Similarly, mixed reality (MR), also referred to as augmented reality, combines computer-generated information (referred to as “virtual content”) with real world images or a real world view to augment, or add content to, a user's view of the world. The simulated environments of virtual reality and/or the mixed environments of augmented reality may thus be utilized to provide an interactive user experience for multiple applications, such as applications that add virtual content to a real-time view of the viewer's environment, interacting with virtual training environments, gaming, remotely controlling drones or other mechanical systems, viewing digital media content, interacting with the Internet, or the like.

However, virtual reality and mixed reality systems may suffer from latency problems, which can cause eyestrain, headaches, and/or nausea. For example, VR and MR systems may involve photon-to-photon latency (e.g., the delay between when a photon is sensed by an image sensor and when it is presented to an eye of the user). Additionally, the amount of image data required to be captured, generated, and/or displayed to the user of a VR system may be so large as to affect the performance of the system (e.g., increased latency) and to increase the cost and/or size of the system.

### SUMMARY

Various embodiments for capturing and displaying image frames out of phase are disclosed. In some embodiments, a method includes storing, in a buffer, lines of pixels of a first image frame exposed by a first image sensor in a buffer. The method also includes providing the lines of pixels of the first image frame from the buffer to a first display, while one or more lines of pixels of a second image frame are exposed by a second image sensor. The method further includes storing the one or more lines of pixels of the second image frame in the buffer subsequent to the one or more lines of pixels of the second image frame being exposed by the second image sensor.

In some embodiments, a system includes a memory to store a buffer and at least one processor. The at least one processor is configured to store lines of pixels of a first image frame exposed by a first image sensor in the buffer. The at least one processor is also configured to provide the lines of pixels of the first image frame from the buffer to a first display, while one or more lines of pixels of a second image frame are exposed by a second image sensor. The at least one processor is further configured to store the one or more lines of pixels of the second image frame in the buffer subsequent to the one or more lines of pixels of the second image frame being exposed by the second image sensor.

In some embodiments, a non-transitory computer readable medium having instructions stored thereon that, when executed by at least one processor, cause the at least one processor to perform operations. The operations include storing, in a buffer, lines of pixels of a first image frame exposed by a first image sensor. The operations also include providing the lines of pixels of the first image frame from the buffer to a first display, while one or more lines of pixels of a second image frame are exposed by a second image sensor. The operations further include storing the one or more lines of pixels of the second image frame in the buffer subsequent to the one or more lines of pixels of the second image frame being exposed by the second image sensor.

### BRIEF DESCRIPTION OF THE DRAWINGS

The accompanying drawings are incorporated herein and form a part of the specification.

FIG. 1A is a first isometric view of an electronic device, according to some embodiments.

FIG. 1B is a second isometric view of an electronic device, according to some embodiments.

FIG. 2 is a block diagram illustrating components in an electronic device, according to some embodiments.

FIG. 3 is a block diagram illustrating image processing pipelines implemented using an image signal processor, according to some embodiments.

FIG. 4 is a block diagram of a system configured to capture and display image frames out of phase, according to some embodiments.

FIG. 5 is a timing diagram illustrating the capture and display of image frames out of phase, according to some embodiments.

FIG. 6 is a flowchart of a method for capturing and displaying image frames out of phase, according to some embodiments.

FIG. 7 is an example computer system that can be used for implementing some aspects or portion(s) thereof.

In the drawings, like reference numbers generally indicate identical or similar elements. Additionally, generally, the left-most digit(s) of a reference number identifies the drawing in which the reference number first appears.

### DETAILED DESCRIPTION

Photon-to-photon latency (e.g., the delay between when a photon is sensed by an image sensor and when it is presented to an eye of the user) should be minimized in a stereoscopic device (e.g., a headset, a helmet, a heads-up display, a pair of glasses, and the like) to avoid issues, such as motion sickness. One technique to minimize this latency is to implement an image processing pipeline for each eye, where each image processing pipeline includes an image sensor, an image signal processor (ISP), and a display. However, such a solution increases the compute resources (e.g., processing, memory, battery, etc.) of the headset. Another option is to utilize a single ISP that is shared between the image sensors and displays. However, if the image sensors are configured to capture images for the left and right eyes at the same time, additional latency will be added because the ISP processing of the image captured for a second eye cannot begin until the processing of an image captured for the first eye is complete.

The embodiments described herein address the above issues. For example, provided herein are system, apparatus, device, method and/or computer program product embodiments, and/or combinations and sub-combinations thereof, for capturing and displaying image frames out of phase for a stereoscopic display (e.g., by utilizing a single ISP). In accordance with such embodiments, the processing and displaying of a first image frame for a first eye and the processing and displaying of a second image frame for a second eye are performed out of phase. For instance, each image sensor may readout its image at different times. While one image sensor is reading out pixels of a first image frame, the other image sensor exposes a second image frame. In some embodiments, a single ISP may process the pixels of the image frame as they are read out by the image sensor that has finished exposing the image frame. The single ISP may process these pixels as they are received from the image sensor, process the pixels for presentation, and provide the processed pixels to the corresponding display. The first image frame and the second image frame are not displayed simultaneously. As such, the displays also run out of phase, where one display displays the first image frame at a first time, and the other display displays the second image frame at a second time.

Such techniques may advantageously improve the functioning of a computing device (e.g., a headset) in which such techniques are implemented. For instance, because a single ISP may be utilized, the power requirements for the computing device are reduced. Moreover, as will be described below, lines of pixels that are read out by each image sensor may be stored in the same buffer. The single ISP and the image sensors may be configured to run at the same frequency (e.g., clock speed) such that the rate at which the image sensors read out lines of pixels and the rate at which the ISP receives and processes the lines of pixels is the same. Accordingly, the size of the buffer utilized to store the lines may be smaller than the size of the image frames, thereby reducing the amount of memory utilized to store the image frames. Moreover, because one image sensor performs exposure and readout of an image frame at any given point in time (rather than being performed simultaneously), the overall current consumed by the computing device is reduced, as power consumption is distributed more evenly. As such, the draw on the power source (e.g., battery) is reduced, thereby enabling a smaller power supply for the computing device.

Embodiments of electronic devices, user interfaces for such devices, and associated processes for using such devices are described herein. In some embodiments, the device is a portable communications device, such as a mobile telephone, that also includes other functions, such as personal digital assistant (PDA) and/or music player functions. Exemplary embodiments of portable multifunction devices include, without limitation, the iPhone®, iPod Touch®, Apple Watch®, and iPad® devices from Apple Inc. of Cupertino, California. Other portable electronic devices, such as wearables, virtual, augmented, or mixed reality headsets, laptops or tablet computers, are optionally used. An exemplary embodiment of a headset includes the Apple Vision Pro® from Apple Inc. In some embodiments, the device is not a portable communication device, but is a desktop computer or other computing device that is not designed for portable use. In some embodiments, the disclosed electronic device may include a touch-sensitive surface (e.g., a touch screen display and/or a touchpad). The electronic device may also include one or more other physical user-interface devices, such as a physical keyboard, a mouse and/or a joystick.

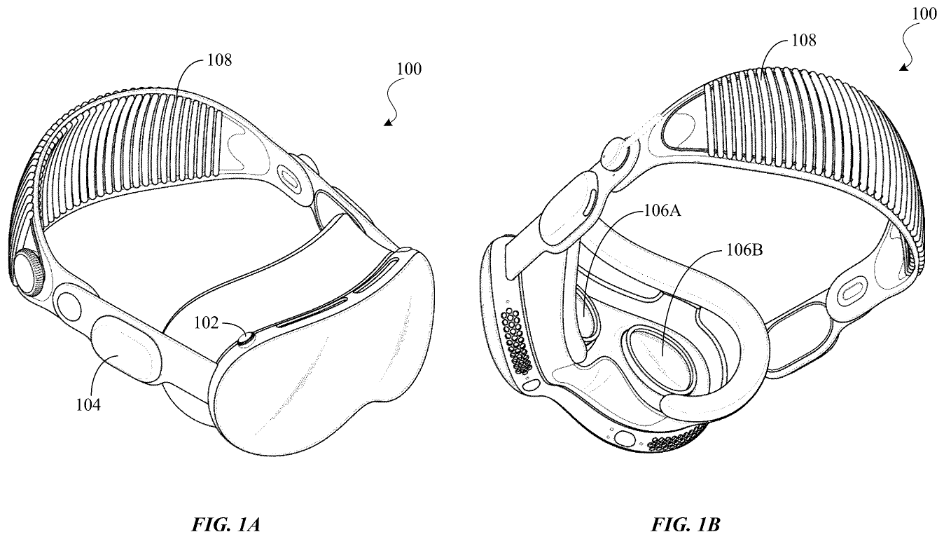

FIGS. 1A and 1B are isometric views of an electronic device 100, according to some embodiments. In the example shown in FIGS. 1A and 1B, device 100 is a stereoscopic headset (e.g., a VR or MR headset). However, it is noted that the embodiments described herein are not so limited. Device 100 may include one or more physical buttons, such as a “home” or menu button 102. Button 102 is, for example, used to navigate to any application in a set of applications that are executed on device 100. Button 102 may also be used to power on or power off electronic device 100. It is noted that device 100 may include buttons in addition to button 102. Device 100 also includes one or more displays 106A and 106B. Display 106A may be configured to display images to a left eye of a user, and display 106B may be configured to display images to a right eye of the user. Displays 106A and 106B may include, for example, a liquid crystal display (LCD) device or an organic light emitting diode (OLED) device. Displays 106A and 106B may display various images, such as menus, selected operating parameters, and images captured by image sensors. As also shown in FIGS. 1A and 1B, device 100 may also include a head strap 108. Head strap 108 may be fixed or adjustable and may be configured in a variety of conventional ways to secure device 100 to a user's face.

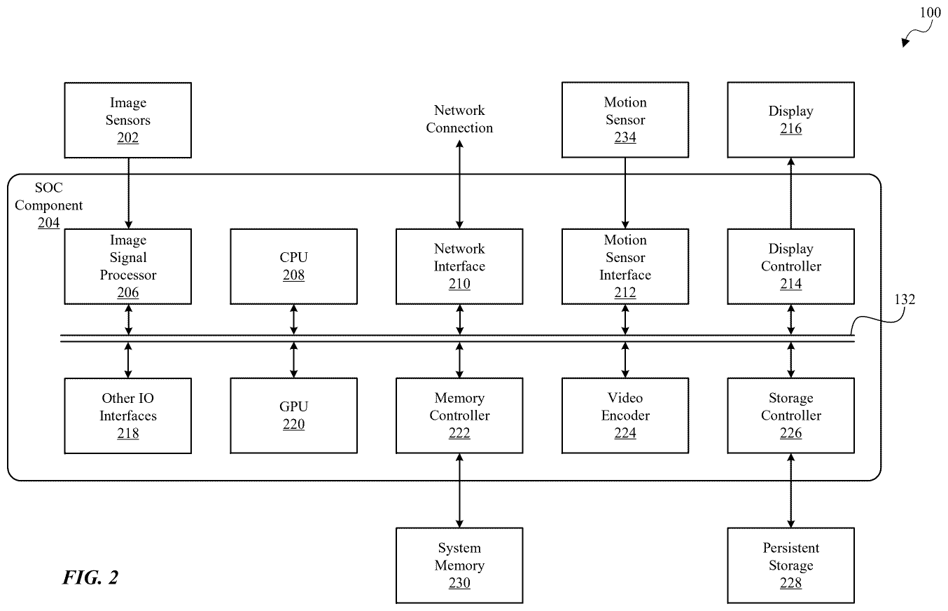

In some embodiments, device 100 includes a speaker 104, audio circuitry, a head set jack, a docking/charging external port, a microphone, a peripherals interface, radio frequency (RF) circuitry, one or more proximity sensors, one or more accelerometers, and one or more gyroscopes, among other components. As will be described below with reference to FIG. 2, device 100 also includes various components such as a memory (which may include one or more computer readable storage mediums), a memory controller, one or more central processing units (CPUs), an input/output (I/O) subsystem, an image signal processor, and one or more image sensors. Device 100 may include more than one type of image sensor. Each type may include more than one image sensor. For example, one type of image sensor may be a camera and another type of image sensor may be an infrared sensor. Device 100 may include additional components not shown in FIG. 1.

Device 100 is only one example of an electronic device, and device 100 may have more or fewer components than listed above, some of which may be combined into a component or have a different configuration or arrangement. The various components of device 100 listed above are embodied in hardware, software, firmware, or a combination thereof, including one or more signal processing and/or application specific integrated circuits (ASICs).

FIG. 2 is a block diagram illustrating components in device 100, according to some embodiments. Device 100 may perform various operations including image processing. For this and other purposes, device 100 may include image sensors 202, a system-on-a chip (SOC) component 204, a system memory 230, a persistent storage (e.g., flash memory) 228, an orientation sensor 234, and a display 216. The components as illustrated in FIG. 2 are merely illustrative. For example, device 100 may include other components (e.g., speaker or microphone) that are not illustrated in FIG. 2. Further, some components (e.g., orientation sensor 234) may be omitted from device 100.

Image sensors 202 are components for capturing image data. Each of image sensors 202 may be embodied, for example, as a complementary metal-oxide-semiconductor (CMOS) active-pixel sensor, a camera, video camera, or other devices. Image sensors 202 generate raw image data that is sent to SOC component 204 for further processing. In some embodiments, the image data processed by SOC component 204 is displayed on display 216, stored in system memory 230 and/or persistent storage 228, or sent to a remote computing device via a network connection. The raw image data generated by image sensors 202 may be in a Bayer color filter array (CFA) pattern (hereinafter also referred to as “Bayer pattern”) or a Quad Bayer pattern (hereinafter also referred to as a “Quadra pattern”). Image sensor 202 may also include optical and mechanical components that assist image sensing components (e.g., pixels) to capture images. The optical and mechanical components may include an aperture, a lens system, and an actuator that controls the focal length of image sensor 202.

Motion sensor 234 is a component or a set of components for sensing motion of device 100. Motion sensor 234 may generate sensor signals indicative of orientation and/or acceleration of device 100. The sensor signals are sent to SOC component 204 for various operations, such as turning on device 100 or rotating images displayed on display 216.

Display 216 is an example of displays 106A and 106B. Display 216 is a component for displaying images as generated by SOC component 204. Display 216 may include, for example, a liquid crystal display (LCD) device or an organic light emitting diode (OLED) device. Based on data received from SOC component 204, display 116 may display various images, such as menus, selected operating parameters, images captured by image sensors 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM), or a combination thereof. In some embodiments, system memory 230 may store pixel data or other image data or statistics in various formats.

Persistent storage 228 is a component for storing data in a non-volatile manner. Persistent storage 228 retains data even when power is not available. Persistent storage 228 may be embodied as read-only memory (ROM), flash memory, or other non-volatile random access memory devices.

SOC component 204 is embodied as one or more integrated circuit (IC) chips and performs various data processing processes. SOC component 204 may include image signal processor (ISP) 206, a central processor unit (CPU) 208, a network interface 210, a motion sensor interface 212, a display controller 214, a graphics processor (GPU) 220, a memory controller 222, a video encoder 224, a storage controller 226, and various other input/output (I/O) interfaces 218, and bus 232 connecting these subcomponents. SOC component 204 may include more or fewer subcomponents than those shown in FIG. 2.

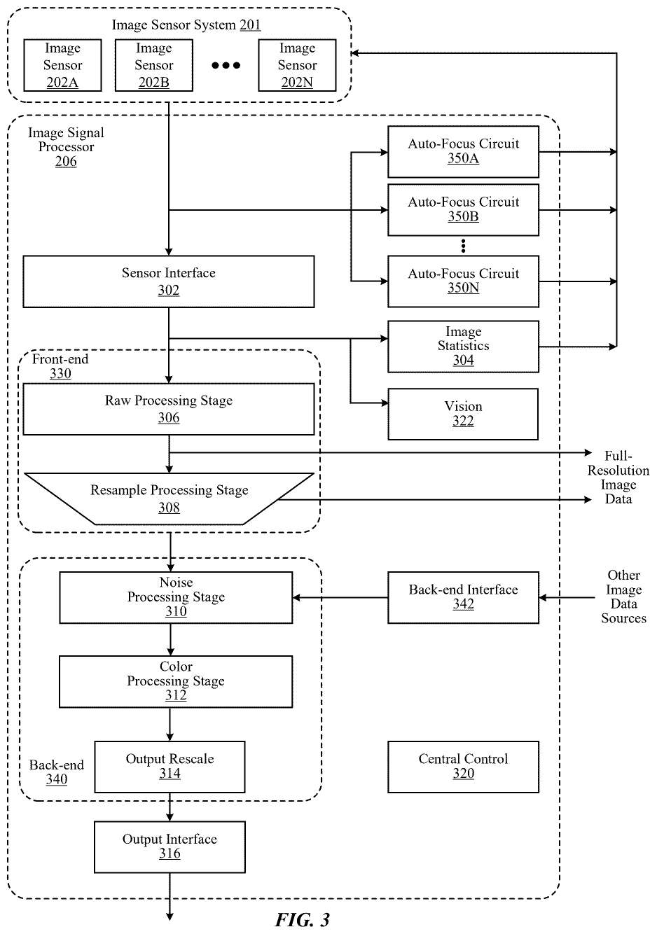

ISP 206 is hardware that performs various stages of an image processing pipeline. In some embodiments, ISP 206 may receive raw image data from image sensors 202 and process the raw image data into a form that is usable by other subcomponents of SOC component 204 or components of device 100. ISP 206 may perform various image-manipulation operations, such as image translation operations, horizontal and vertical scaling, color space conversion and/or image stabilization transformations, as described below in detail with reference to FIG. 3.

CPU 208 may be embodied using any suitable instruction set architecture and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may commonly, but not necessarily, implement the same ISA.

Graphics processing unit (GPU) 220 is graphics processing circuitry for performing operations on graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

I/O interfaces 218 are hardware, software, firmware or combinations thereof for interfacing with various input/output components in device 100. I/O components may include devices, such as keypads, buttons, audio devices, and sensors (e.g., a global positioning system). I/O interfaces 218 process data for sending data to such I/O components or process data received from such I/O components.

Network interface 210 is a subcomponent that enables data to be exchanged among devices 100 and other devices via one or more networks (e.g., carrier or agent devices). For example, video or other image data may be received from other devices via network interface 210 and be stored in system memory 230 for subsequent processing (e.g., via a back-end interface to image signal processor 206, such as discussed below in FIG. 3) and display. The networks may include, Local Area Networks (LANs) (e.g., an Ethernet or corporate network) and Wide Area Networks (WANs). The image data received via network interface 210 may undergo image processing processes by ISP 206.

Motion sensor interface 212 is circuitry for interfacing with motion sensor 234. Motion sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220, or other subcomponents of SOC component 204. Memory controller 222 may also write data to system memory 230 received from various subcomponents of SOC component 204.

Video encoder 224 is hardware, software, firmware, or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on ISP 206, CPU 208, or GPU 220. Such software components may be stored in system memory 230, persistent storage 228, or another device communicating with device 100 via network interface 210.

Image data or video data may flow through various data paths within SOC component 204. In one example, raw image data may be generated from image sensors 202 and processed by ISP 206 and then sent to system memory 230 via bus 232 and memory controller 222. After the image data is stored in system memory 230, it may be accessed by video encoder 224 for encoding or by display 116 for displaying via bus 232.

In another example, image data is received from sources other than image sensors 202. For example, video data may be streamed, downloaded, or otherwise communicated to SOC component 204 via wired or wireless network. The image data may be received via network interface 210 and written to system memory 230 via memory controller 222. The image data may then be obtained by ISP 206 from system memory 230 and processed through one or more image processing pipeline stages, as described below in detail with reference to FIG. 3. The image data may then be returned to system memory 230 or be sent to video encoder 224, display controller 214 (e.g., for display on display 216), or storage controller 226 for storage at persistent storage 228.

FIG. 3 is a block diagram illustrating image processing pipelines implemented using ISP 206, according to some embodiments. In some embodiments, ISP 206 is coupled to an image sensor system 201 that includes one or more image sensors 202A through 202N (hereinafter collectively referred to as “image sensors 202” or also referred individually as “image sensor 202”) to receive raw image data. Image sensor system 201 may include one or more sub-systems that control image sensors 202 individually. In some embodiments, each image sensor 202 may operate independently while, in other cases, image sensors 202 may share one or more components. For example, two or more image sensors 202 may share the same circuit board that controls the mechanical components of the image sensors (e.g., actuators that change the focal lengths of each image sensor). The image sensing components of image sensor 202 may include different types of image sensing components that may provide raw image data in different forms to ISP 206. For example, the image sensing components may include multiple focus pixels that are used for auto-focusing and multiple image pixels that are used for capturing images. In some embodiments, the image sensing pixels may be used for both auto-focusing and image capturing purposes.

ISP 206 implements an image processing pipeline which may include a set of stages that process image information from creation, capture, or receipt to output. ISP 206 may include a sensor interface 302, a central control 320, front-end pipeline stages 330, back-end pipeline stages 340, an image statistics module 304, a vision module 322, a back-end interface 342, an output interface 316, and auto-focus circuits 350A through 350N (hereinafter collectively referred to as “auto-focus circuits 350” or referred individually as “auto-focus circuits 350”). ISP 206 may include other components not illustrated in FIG. 3 or may omit one or more components illustrated in FIG. 3.

In some embodiments, different components of ISP 206 process image data at different rates. In some embodiments, front-end pipeline stages 330 (e.g., raw processing stage 306 and resample processing stage 308) may process image data at an initial data rate. Thus, the various different techniques, adjustments, modifications, or other processing operations may be performed by these front-end pipeline stages 330 at the initial data rate. For example, if front-end pipeline stages 330 process two pixels per clock cycle, then raw processing stage 306 operations (e.g., black level compensation, highlight recovery, and defective pixel correction) may process two pixels of image data at a time. In contrast, one or more back-end pipeline stages 340 may process image data at a different data rate less than the initial data rate. For example, in some embodiments, back-end pipeline stages 340 (e.g., noise processing stage 310, color processing stage 312, and output rescale 314) may be processed at a reduced data rate (e.g., one pixel per clock cycle).

Raw image data captured by image sensors 202 may be transmitted to different components of ISP 206 in different manners. In some embodiments, raw image data corresponding to the focus pixels may be sent to auto-focus circuits 350 while raw image data corresponding to the image pixels may be sent to sensor interface 302. In some embodiments, raw image data corresponding to both types of pixels may simultaneously be sent to both auto-focus circuits 350 and sensor interface 302.

Auto-focus circuits 350 may include a hardware circuit that analyzes raw image data to determine an appropriate focal length of each image sensor 202. In some embodiments, the raw image data may include data that is transmitted from image sensing pixels that perform image focusing operations. In some embodiments, raw image data from image capture pixels may also be used for auto-focusing purposes. Auto-focus circuit 350 may perform various image processing operations to generate data that determines the appropriate focal length. The image processing operations may include cropping, binning, image compensation, and scaling to generate data that is used for auto-focusing purposes, etc. The auto-focusing data generated by auto-focus circuits 350 may be fed back to image sensor system 201 to control the focal lengths of image sensors 202. For example, image sensor 202 may include a control circuit that analyzes the auto-focusing data to determine a command signal that is sent to an actuator associated with the lens system of image sensor 202 to change the focal length of image sensor 202. The data generated by auto-focus circuits 350 may also be sent to other components of ISP 206 for other image processing purposes. For example, some of the data may be sent to image statistics module 304 to determine information regarding auto-exposure.

Auto-focus circuits 350 may be individual circuits that are separate from other components, such as image statistics module 304, sensor interface 302, front-end 330, and back-end 340. This allows ISP 206 to perform auto-focusing analysis independent of other image processing pipelines. For example, ISP 206 may analyze raw image data from image sensor 202A to adjust the focal length of image sensor 202A using auto-focus circuit 350A while performing downstream image processing of the image data from image sensor 202B simultaneously. In some embodiments, the number of auto-focus circuits 350 may correspond to the number of image sensors 202. In other words, each image sensor 202 may have a corresponding auto-focus circuit that is dedicated to the auto-focusing of image sensor 202. Device 100 may perform auto focusing for different image sensors 202 even if one or more image sensors 202 are not in active use. This allows a seamless transition between two image sensors 202 when device 100 switches from one image sensor 202 to another. For example, device 100 may include a wide-angle camera and a telephoto camera as a dual back camera system for photo and image processing. Device 100 may display images captured by one of the dual cameras and may switch between the two cameras from time to time. The displayed images may seamless transition from image data captured by one image sensor 202 to image data captured by another image sensor 202 without waiting for second image sensor 202 to adjust its focal length because two or more auto-focus circuits 350 may continuously provide auto-focus data to image sensor system 201.

Raw image data captured by different image sensors 202 may also be transmitted to sensor interface 302. Sensor interface 302 receives raw image data from image sensors 202 and processes the raw image data into an image data processable by other stages in the pipeline. Sensor interface 302 may perform various preprocessing operations, such as image cropping, binning, and scaling, to reduce image data size. In some embodiments, pixels are sent from image sensors 202 to sensor interface 302 in raster order (e.g., horizontally, line by line). The subsequent processes in the pipeline may also be performed in raster order and the result may also be output in raster order. Although only a single image sensor system 201 and a single sensor interface 302 are illustrated in FIG. 3, when more than one image sensor system is provided by device 100, a corresponding number of sensor interfaces may be provided in ISP 206 to process raw image data from each image sensor system.

Front-end pipeline stages 330 process image data in raw or full-color domains. Front-end pipeline stages 330 may include raw processing stage 306 and resample processing stage 308. A raw image data may be in a Bayer raw image format or a Quadra raw image format, for example. In such raw image format, pixel data with values specific to a particular color (instead of all colors) is provided in each pixel. In an image capturing sensor, image data can be provided in the Bayer or Quadra pattern. Raw processing stage 306 may process image data in the Bayer or Quadra raw image format.

The operations performed by raw processing stage 306 include sensor linearization, black level compensation, fixed pattern noise reduction, defective pixel correction, raw noise filtering, lens shading correction, white balance gain, highlight recovery, and downsampling. Sensor linearization refers to mapping non-linear image data to linear space for other processing. Black level compensation refers to providing digital gain, offset, and clip independently for each color component (e.g., Gr, R, B, Gb) of the image data. Fixed pattern noise reduction refers to removing offset fixed pattern noise and gain fixed pattern noise by subtracting a dark frame from an input image and multiplying different gains to pixels. Defective pixel correction refers to detecting defective pixels, and then replacing defective pixel values. Raw noise filtering refers to reducing noise of image data by averaging neighboring pixels that are similar in brightness. Highlight recovery refers to estimating pixel values for those pixels that are clipped (or nearly clipped) from other channels. Lens shading correction refers to applying a gain per pixel to compensate for a dropoff in intensity roughly proportional to a distance from a lens optical center. White balance gain refers to providing digital gains for white balance, offset and clip independently for all color components (e.g., Gr, R, B, Gb in the Bayer pattern). Downsampling refers to reducing the resolution of an image (or certain regions thereof) by discarding pixels.

Components of ISP 206 may convert raw image data into image data in full-color domain, and thus raw processing stage 306 may process image data in the full-color domain in addition to or instead of raw image data.

Resample processing stage 308 performs various operations to convert, resample, or scale image data received from raw processing stage 306. Operations performed by resample processing stage 308 may include a demosaic operation, a per-pixel color correction operation, a Gamma mapping operation, a color space conversion, and a downscaling or sub-band splitting. The demosaic operation refers to converting or interpolating missing color samples from raw image data (e.g., in the Bayer pattern) to output image data into a full-color domain. The demosaic operation may include low pass directional filtering on the interpolated samples to obtain full-color pixels. The per-pixel color correction operation refers to a process of performing color correction on a per-pixel basis using information about relative noise standard deviations of each color channel to correct color without amplifying noise in the image data. The Gamma mapping operation refers to converting image data from input image data values to output data values to perform gamma correction. For the purpose of the Gamma mapping operation, lookup tables (or other structures that index pixel values to another value) for different color components or channels of each pixel (e.g., a separate lookup table for R, G, and B color components) may be used. The color space conversion refers to converting color space of an input image data into a different format. In some embodiments, resample processing stage 308 converts RGB format into YCbCr format for further processing.

Central control module 320 may control and coordinate overall operation of other components in ISP 206. Central control module 320 performs operations including monitoring various operating parameters (e.g., logging clock cycles, memory latency, quality of service, and state information), updating or managing control parameters for other components of ISP 206, and interfacing with sensor interface 302 to control the starting and stopping of other components of ISP 206. For example, central control module 320 may update programmable parameters for other components in ISP 206 while the other components are in an idle state. After updating the programmable parameters, central control module 320 may place these components of ISP 206 into a run state to perform one or more operations or tasks. Central control module 320 may also instruct other components of ISP 206 to store image data (e.g., by writing to system memory 230 in FIG. 2) before, during, or after resample processing stage 308. In this way, full-resolution image data in raw or full-color domain format may be stored in addition to or instead of processing the image data output from resample processing stage 308 through backend pipeline stages 340.

Image statistics module 304 performs various operations to collect statistics information associated with the image data. The operations for collecting the statistics information may include sensor linearization, replacing patterned defective pixels, sub-sampling raw image data, detection and replacement of non-patterned defective pixels, black level compensation, lens shading correction, and inverse black level compensation. After performing one or more of such operations, statistics information (e.g., 3A statistics (auto-focus, auto white balance (AWB), auto exposure (AE)), histograms (e.g., 2D color or component), and any other image data information) may be collected or tracked. In some embodiments, certain pixels' values or areas of pixel values may be excluded from collections of certain statistics data when preceding operations identify clipped pixels. Although only a single statistics module 304 is illustrated in FIG. 3, multiple image statistics modules may be included in ISP 206. For example, each image sensor 202 may correspond to an individual image statistics module 304. In some embodiments, each statistic module may be programmed by central control module 320 to collect different information for the same or different image data.

Vision module 322 performs various operations to facilitate computer vision operations at CPU 208, such as facial detection in image data. Vision module 322 may perform various operations including pre-processing, global tone-mapping and Gamma correction, vision noise filtering, resizing, keypoint detection, generation of histogram-of-orientation gradients (HOG), and normalized cross correlation (NCC). The pre-processing may include a subsampling or binning operation and computation of luminance if the input image data is not in YCrCb format. Global mapping and Gamma correction can be performed on the pre-processed data on luminance image. Vision noise filtering is performed to remove pixel defects and reduce noise present in the image data, and thereby improve the quality and performance of subsequent computer vision algorithms. Such vision noise filtering may include detecting and fixing dots or defective pixels and performing bilateral filtering to reduce noise by averaging neighboring pixels of similar brightness. Various vision algorithms use images of different sizes and scales. Resizing of an image is performed, for example, by binning or linear interpolation operation. Keypoints are locations within an image that are surrounded by image patches well suited to matching in other images of the same scene or object. Such keypoints are useful in image alignment, computing camera pose, and object tracking. Keypoint detection refers to the process of identifying such keypoints in an image. HOG provides descriptions of image patches for tasks in image analysis and computer vision. HOG can be generated, for example, by (i) computing horizontal and vertical gradients using a difference filter, (ii) computing gradient orientations and magnitudes from the horizontal and vertical gradients, and (iii) binning the gradient orientations. NCC is the process of computing spatial cross-correlation between a patch of image and a kernel.

Back-end interface 342 receives image data from other image sources than image sensor 102 and forwards the image data to other components of ISP 206 for processing. For example, image data may be received over a network connection and be stored in system memory 230. Back-end interface 342 retrieves the image data stored in system memory 230 and provides the image data to back-end pipeline stages 340 for processing. Back-end interface 342 may convert the retrieved image data to a format that can be utilized by back-end processing stages 340. For instance, back-end interface 342 may convert RGB, YCbCr 4:2:0, or YCbCr 4:2:2 formatted image data into YCbCr 4:4:4 color format.

Back-end pipeline stages 340 processes image data according to a particular full-color format (e.g., YCbCr 4:4:4 or RGB). In some embodiments, components of the back-end pipeline stages 340 may convert image data to a particular full-color format before further processing. Back-end pipeline stages 340 may include noise processing stage 310 and color processing stage 312. Back-end pipeline stages 340 may include other stages not illustrated in FIG. 3.

Noise processing stage 310 performs various operations to reduce noise in the image data. The operations performed by noise processing stage 310 include color space conversion, gamma/de-gamma mapping, temporal filtering, noise filtering, luma sharpening, and chroma noise reduction. The color space conversion may convert an image data from one color space format to another color space format (e.g., RGB format converted to YCbCr format). Gamma/de-gamma operation converts image data from input image data values to output data values to perform gamma correction or reverse gamma correction. Temporal filtering filters noise using a previously-filtered image frame to reduce noise. For example, pixel values of a prior image frame are combined with pixel values of a current image frame. Noise filtering may include, for example, spatial noise filtering. Luma sharpening may sharpen luma values of pixel data while chroma suppression may attenuate chroma to gray (e.g., no color). In some embodiments, the luma sharpening and chroma suppression may be performed simultaneously with spatial nose filtering. The aggressiveness of noise filtering may be determined differently for different regions of an image. Spatial noise filtering may be included as part of a temporal loop implementing temporal filtering. For example, a previous image frame may be processed by a temporal filter and a spatial noise filter before being stored as a reference frame for a next image frame to be processed. In some embodiments, spatial noise filtering may not be included as part of the temporal loop for temporal filtering (e.g., the spatial noise filter may be applied to an image frame after it is stored as a reference image frame and thus the reference frame is not spatially filtered).

Color processing stage 312 may perform various operations associated with adjusting color information in the image data. The operations performed in color processing stage 312 include local tone mapping, gain/offset/clip, color correction, three-dimensional color lookup, gamma conversion, and color space conversion. Local tone mapping refers to spatially varying local tone curves in order to provide more control when rendering an image. For instance, a two-dimensional grid of tone curves (which may be programmed by central control module 320) may be bilinearly interpolated such that smoothly varying tone curves are created across an image. In some embodiments, local tone mapping may also apply spatially varying and intensity varying color correction matrices, which may, for example, be used to make skies bluer while turning down blue in the shadows in an image. Digital gain/offset/clip may be provided for each color channel or component of image data. Color correction may apply a color correction transform matrix to image data. 3D color lookup may utilize a three-dimensional array of color component output values (e.g., R, G, B) to perform advanced tone mapping, color space conversions, and other color transforms. Gamma conversion may be performed, for example, by mapping input image data values to output data values in order to perform gamma correction, tone mapping, or histogram matching. Color space conversion may be implemented to convert image data from one color space to another (e.g., RGB to YCbCr). Other processing techniques may also be performed as part of color processing stage 312 to perform other imaging operations, including black and white conversion, sepia tone conversion, negative conversion, or solarize conversion.

Output rescale module 314 may resample, transform, and correct distortion on the fly as ISP 206 processes image data. Output rescale module 314 may compute a fractional input coordinate for each pixel and use this fractional coordinate to interpolate an output pixel via a polyphase resampling filter. A fractional input coordinate may be produced from a variety of possible transforms of an output coordinate, such as resizing or cropping an image (e.g., via a simple horizontal and vertical scaling transform), rotating and shearing an image (e.g., via non-separable matrix transforms), perspective warping (e.g., via an additional depth transform) and per-pixel perspective divides applied in piecewise in strips to account for changes in image sensor during image data capture (e.g., due to a rolling shutter), and geometric distortion correction (e.g., via computing a radial distance from the optical center in order to index an interpolated radial gain table, and applying a radial perturbance to a coordinate to account for a radial lens distortion).

Output rescale module 314 may apply transforms to image data as it is processed at output rescale module 314. Output rescale module 314 may include horizontal and vertical scaling components. The vertical portion of the design may implement a series of image data line buffers to hold the “support” needed by the vertical filter. As ISP 206 may be a streaming device, it may be that only the lines of image data in a finite-length sliding window of lines are available for the filter to use. Once a line has been discarded to make room for a new incoming line, the line may be unavailable. Output rescale module 314 may statistically monitor computed input Y coordinates over previous lines and use it to compute an optimal set of lines to hold in the vertical support window. For each subsequent line, output rescale module may automatically generate a guess as to the center of the vertical support window. In some embodiments, the output rescale module 314 may implement a table of piecewise perspective transforms encoded as digital difference analyzer (DDA) steppers to perform a per-pixel perspective transformation between an input image data and output image data in order to correct artifacts and motion caused by sensor motion during the capture of the image frame. Output rescale may provide image data via output interface 316 to various other components of device 100, as discussed above with reference to FIGS. 1 and 2.

In some embodiments, the functionally of components 302 through 350 may be performed in a different order than the order implied by the order of these functional units in the image processing pipeline illustrated in FIG. 3 or may be performed by different functional components than those illustrated in FIG. 3. Moreover, the various components as described in FIG. 3 may be embodied in various combinations of hardware, firmware, or software.

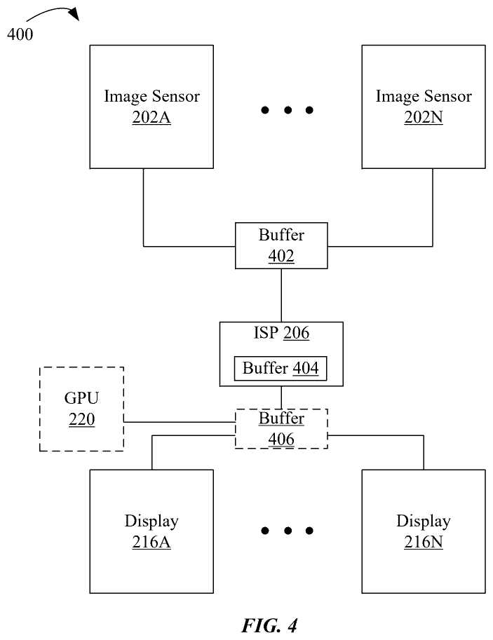

FIG. 4 is a block diagram of a system 400 configured to capture and display image frames out of phase, according to some embodiments. As shown in FIG. 4, system 400 includes two or more image sensors 202A-202N, ISP 206, two or more displays 216A-216N, and a buffer 402. Each of displays 216A-216N are examples of display 216, as described above with reference to FIG. 2. During exposure of a particular image frame, each of image sensors 202A-202N is configured to receive light (e.g., photons) that is focused through a lens or other optics. Each of image sensors 202A-202N may perform photoelectric conversion, which converts the photos into electrons. The electrons are then accumulated as an electrical charge within each pixel of the image sensor, gradually building up during the exposure time. After exposure is complete, the accumulated electrons may be converted to an electrical signal (e.g., a voltage). Each of image sensors 202A-202N may convert the voltage to a digital value, for example, using analog-to-digital converters (ADCs) (not shown for brevity). In some embodiments, when capturing an image frame, each line (or row) of pixels of a particular image sensor is exposed to light simultaneously (referred to as “a global shutter capturing technique”). In other embodiments, each line of pixels of a particular image sensor is exposed to light sequentially one line at a time (referred to as “a rolling shutter capturing technique”).

After each of image sensors 202A-202N completes the exposure of a line of pixels of an image frame, image sensor 202A-202N may provide the exposed line of pixels to buffer 402. The process of providing exposed lines of pixels may be referred to as “sensor readout.” In an embodiment in which a rolling shutter capturing technique is utilized, a line of pixels is provided to buffer 402 as soon as its exposure has completed (rather than waiting for all the lines of the image frame to be exposed first). As such, a first set of lines of an image frame may be provided to buffer 402, while a second set of lines of the same image frame are being exposed. The readout of each of image sensors 202A-202N may occur out of phase (e.g., by half a frame) such that the readout of one image sensor does not overlap the readout of another image sensor, while the exposures of different image sensors 202A-202N may overlap. Sensor readout may be faster than exposure time. For example, exposure time may be 10 milliseconds, whereas sensor readout may be 3-4 milliseconds.

ISP 206 may be configured to alternate between processing and displaying an image frame captured by one image sensor (e.g., image sensor 202A) and processing and display an image frame captured by another image sensor (e.g., image sensor 202N). For instance, during a first period, ISP 206 may obtain lines of a first image frame stored in buffer 402, process the first image frame captured by a first image sensor (e.g., image sensor 202A) of image sensors 202A-202N, and provide the lines of the first image frame to a first display (e.g., display 216A) for display. During a second time period, ISP 206 may obtain lines of a second image frame stored in buffer 402, process the second image frame captured by a second image sensor (e.g., image sensor 202N) of image sensors 202A-202N, and provide the lines of the second image frame to a second display (e.g., display 216N) for display. The processing time of ISP 206 may be faster than an exposure time. For example, the exposure time may be 10 milliseconds, whereas the processing time may be 3-4 milliseconds. In some embodiments, image sensors 202A-202N are configured to capture image frames, and displays 216A-216N are configured to display image frames at the same rate (e.g., at least 90 frames per second). Accordingly, the difference in time in which the first image frame and the second image frame are displayed via displays 216A-216N is not perceptible to the eyes of the users. It is noted that each of displays 216A-216N do not display any empty or black frames between image frames. Instead, each of displays 216A-216N display image frames at the full frame rate. However, the processing and display of image frames between image sensors 202A-202N are performed out of phase (e.g., by half a frame). For instance, each of displays 216A-216N may display a new frame every 10 ms, but one display of displays 216A-216N may start displaying 5 ms before another display of displays 216A-216N.

In some embodiments, buffer 402 is configured as a queue, where each line of pixels is stored in a respective entry of the queue (e.g., a first in, first out (FIFO)-based data structure). In accordance with such embodiments, the order in which the line of pixels are stored in buffer 402 by an image sensor is the same order in which the line of pixels are read out by ISP 206. That is, the oldest line of pixels stored in buffer 402 is read out by ISP 206 before the other lines of pixels.

To minimize latency, ISP 206 and image sensors 202A-202N may be configured to run at the same frequency (e.g., clock speed) such that the rate at which image sensors 202A-202N read out lines of pixels to buffer 402 and the rate at which ISP 206 obtains the lines of pixels from buffer 402 and processes the lines of pixels is the same. ISP 206 may obtain the lines of pixels from buffer 402 sequentially on a line-by-line basis as they are stored in buffer 402. Buffer 402 may be configured to store a number of lines of pixels that is less than the total number of lines of pixels of the image frame. Accordingly, buffer 402 may not store the entire image frame. Thus, ISP 206 does not wait for the entire image frame to be stored in buffer 402 before reading the lines of pixels from buffer 402. In some embodiments, ISP 206 reads a line of pixels from buffer 206 as soon as it is stored in buffer 402. For instance, buffer 206 may provide a signal to ISP 206 that indicates that a line of pixels has been stored therein. In response to receiving the signal, ISP 206 may read the oldest line of pixels that stored in buffer 402. In some embodiments, ISP 206 does not begin reading lines of pixels from buffer 402 until buffer 402 is full. For instance, suppose buffer 402 is configured to hold a maximum of 200 lines of pixels. After buffer 402 stores the maximum number of lines of pixels, buffer 402 may provide a signal to ISP 206 that indicates that buffer 402 is full. In response to receiving the signal, ISP 206 may start reading the lines of pixels one line at a time. An image sensor may store additional lines of pixels of a particular image frame in buffer 402 as lines of pixels are read out by ISP 206.

While image sensor 202A reads out the lines of pixels to buffer 402, image sensor 202N may begin to expose its image frame, where the pixels for the image frame of image sensor 202N are exposed to a light source. When exposure of a line of pixels is complete, image sensor 202N may read out the exposed line of pixels to buffer 402. Image sensor 202A will have completed reading out its lines prior to image sensor 202N beginning its readout.

Because the readout of image frames between image sensors 202A-202N are not performed simultaneously, the overall current consumed by the computing device is advantageously reduced, as power consumption is distributed more evenly. For instance, the ADCs of a particular image sensor may be activated during sensor readout and deactivated when not performing sensor readout. Because sensor readout of image sensors 202A-202N are not performed simultaneously, just the ADCs of a particular image sensor are activated at any given point in time.

ISP 206 may include a buffer 404 that stores the lines of pixels read from buffer 402. ISP 206 may process the lines of pixels stored in buffer 404, for example, in accordance with raw processing stage 306, resample processing stage 308, noise processing stage 310, color processing stage 312, and/or output rescale module 314, as described above with reference to FIG. 3. After a line of pixel is processed, ISP 206 may provide the processed line of pixels to a display (e.g., display 216A) of displays 216A-216N for display. ISP 206 may provide the processed lines of pixels to the display on a line-by-line basis (e.g., one processed line of pixels at a time). ISP 206 continues to provide the processed lines to the display until the last processed line of the image frame is provided to the display.

After the last line of pixels of an image frame is stored in buffer 402, the image sensor providing the lines of pixels to buffer 402 may provide a signal (e.g., an end-of-frame signal) to ISP 206 indicating that readout of the image frame to buffer 402 is complete. Based on the signal, ISP 206 determines that the lines of pixels stored in buffer 402 subsequent to receiving the signal are for a different image frame provided by another image sensor (e.g., image sensor 202N). Accordingly, when ISP 206 reads such a line of pixels from buffer 302, ISP 206 switches from processing and displaying lines of pixels of the first image frame captured by a first image sensor (e.g., image sensor 202A) via display 216A to processing and displaying lines of pixels of the second image frame captured by a second image sensor (e.g., image sensor 202N) via display 216N.

Similar to buffer 402, buffer 404 may be configured to store a number of lines of pixels that is less than the total number of lines of pixels for an image frame. Additionally, buffer 404 may also be configured as a queue, where each line of pixels is stored in a respective entry of the queue. The order in which the lines of pixels are stored in buffer 404 by ISP 206 is the same order in which ISP 206 provides the lines of pixels to a display of displays 216A-216N. That is, the oldest line of pixels stored in buffer 404 is provided to a display before the other lines of pixels.

In some embodiments, system 400 may further include a buffer 406 and a GPU 220. ISP 206 may store lines of pixels in buffer 406 before the lines of pixels are provided to a display. GPU 220 may be configured to render objects (e.g., text, a user interface, two-dimensional objects, or three-dimensional objects) over the lines of pixels. After the rendering of objects is complete, the lines of pixels may be provided to a display. For example, ISP 206 or GPU 220 may provide a signal to buffer 406, which causes buffer 406 to provide the lines of pixels to a display.

Similar to buffer 404, buffer 406 may be configured to store a number of lines of pixels that is less than the total number of lines of pixels for an image frame. Additionally, buffer 406 may also be configured as a queue, where each line of pixels is stored in a respective entry of the queue. The order in which the lines of pixels are stored in buffer 406 by ISP 206 is the same order in which the lines of pixels are provided to a display of displays 216A-216N. That is, the oldest line of pixels stored in buffer 406 is provided to a display before the other lines of pixels.

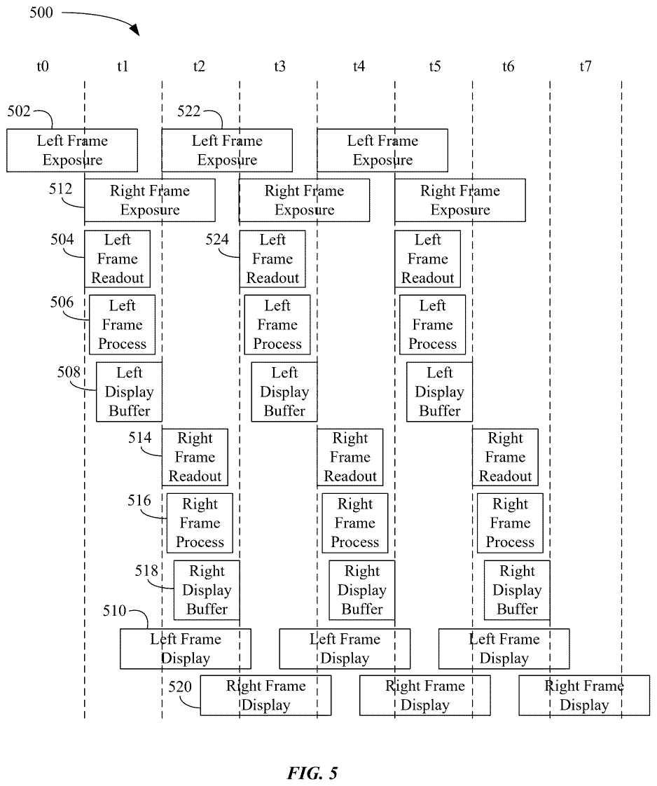

It is noted that while the embodiment described with reference to FIG. 5 is directed to utilizing one ISP (e.g., ISP 206), the embodiments described herein are not so limited. For instance, more than one ISP may be utilized. In accordance with such embodiments, each ISP may perform out of phase processing of image frames captured from a respective plurality of image sensors of image sensors 202A-202N.

FIG. 5 a timing diagram 500 illustrating the capture and display of image frames out of phase, according to some embodiments. In the example shown in FIG. 5, two image sensors, two displays, and a single ISP are utilized. One image sensor and display are utilized to display images to a left eye of a user, and another image sensor and display are utilized to display images to a right eye of a user, for example, in an embodiment in which the image sensors and displays are incorporated into a headset (as shown in FIG. 1). Timing diagram 500 will be described with reference to system 400 of FIG. 4.

During a first time period (t0), an image sensor (e.g., image sensor 202A) configured to capture a first image frame for display to a left eye of a user may expose, at 502, the first image frame. During a second time period (t1), image sensor 202A, at 504, may read out the exposed lines of pixels to buffer 402. Once one or more lines of pixels are stored in buffer 402, ISP 206 may read the lines of pixels from buffer 402, store such lines of pixels in buffer 404 and/or process such lines of pixels at 506. The processed lines of pixels may be provided to buffer 406 at 508, which are subsequently provided, at 510, to a display configured to display the first image frame to the left eye of the user (e.g., display 216A). Operation 506 is depicted as being offset from operation 504 to represent the delay caused from storing and reading the one or more lines to and from buffer 402. As also shown in FIG. 5, during the second time period (t1), an image sensor (e.g., image sensor 202N) configured to capture a second image frame for display to a right eye of the user may, at 512, expose the second image frame while the first image frame is read out to buffer 402 by image sensor 202A at operation 504 and while ISP 206 processes and provides lines of pixels of the first image frame to display 216A at operations 506, 508, and 510.

During a third time period (t2), image sensor 202N, at 514, may read out the exposed lines of pixels of the second image frame to buffer 402. Once one or more lines of pixels are stored in buffer 402, ISP 206 may read the lines of pixels from buffer 402, store such lines of pixels in buffer 404 and/or process such lines of pixels at 516. The processed lines of pixels may be provided to buffer 406 at 518, which are subsequently provided, at 520, to a display configured to display the second image frame to the right eye of the user (e.g., display 216N). Operation 516 is depicted as being offset from operation 514 to represent the delay caused from storing and reading the one or more to and from buffer 402. As also shown in FIG. 5, during the third time period (t2), image sensor 202A may expose, at 522, another image frame for the left eye (e.g., a third image frame) while the second image frame is read out to buffer 402 by image sensor 202N at 514 and while ISP 206 processes and provides lines of pixels of the first image frame to display 216A at operations 516, 518, and 520.

During a fourth time period (t3), image sensor 202A reads out the lines of pixels of the third image frame to buffer 402, at 524, and ISP 206 processes, buffers, and displays the lines of pixels of the third image frame while image sensor 202N exposes a fourth image frame to be displayed to the right eye of the user in a similar manner as described above with reference to the second time period (t1). Similarly, during a fifth time period (t4), image sensor 202N reads out the lines of pixels of the fourth image frame to buffer 402 and ISP 206 processes, buffers, and displays the lines of pixels of the fourth image frame while image sensor 202A exposes a fifth image frame to be displayed to the left eye of the user in a similar manner as described above with reference to the third time period (t2). The foregoing process continues (e.g., during subsequent time periods (e.g., t5, t6, and t7) until image frames are no longer desired to be displayed to the user (e.g., when the headset is powered off or placed in standby mode).

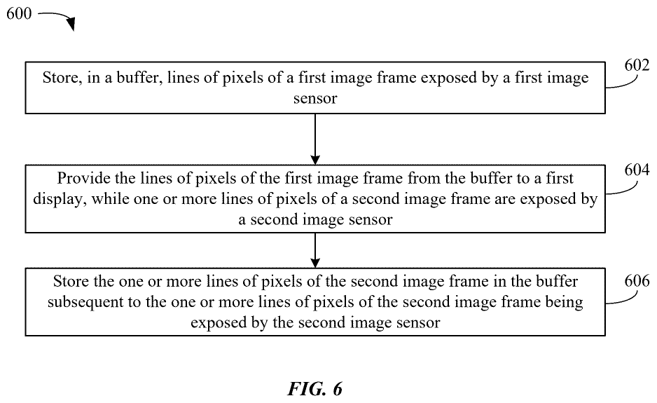

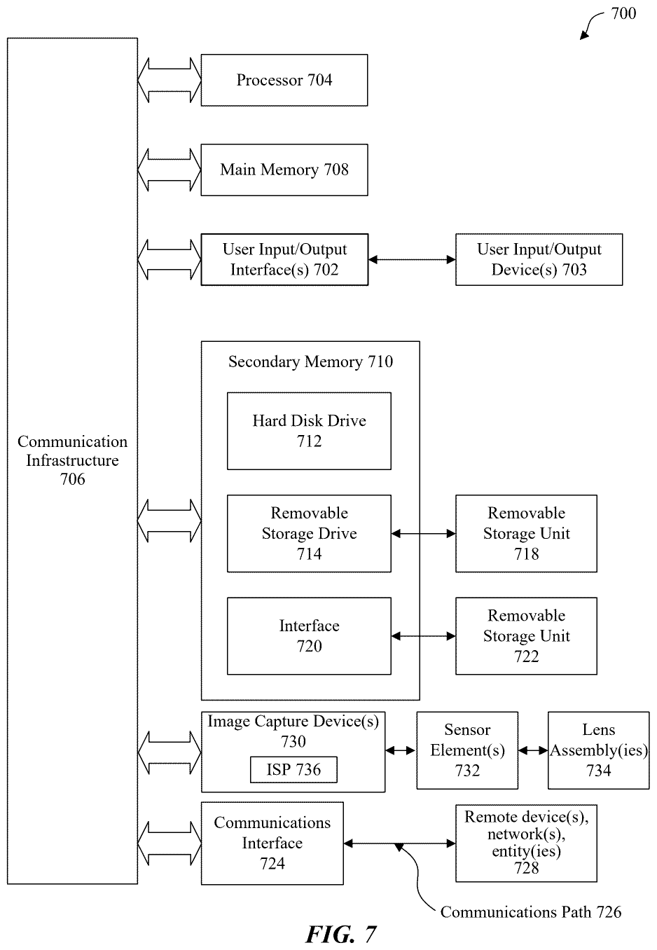

FIG. 6 is a flowchart of a method 600 for capturing and displaying image frames out of phase, according to some embodiments. In some embodiments, method 600 can be performed by a single ISP with processing logic that can include hardware (e.g., circuitry, dedicated logic, programmable logic, and microcode), software (e.g., instructions executing on a processing device), or a combination thereof. It is to be appreciated that not all operations may be performed simultaneously, or in a different order than shown in FIG. 7.

Method 600 shall be described with reference to FIGS. 4 and 5. Method 600 is not limited to that example embodiment.

In 602, ISP 206 may store, in buffer 404, lines of pixels of a first image frame exposed by a first image sensor (e.g., image sensor 202A). For example, as shown in FIG. 5, during the first time period (t0), image sensor 202A may, at 502, expose lines of pixels of a first image frame. During the second time period (t1), image sensor 202A may, at 504, provide the exposed lines of pixels of the first image frame to buffer 402 for storage. At 506, ISP 206 may read the lines of pixels of the first image frame from buffer 402 and store the lines of pixels in buffer 404 for processing.

In some embodiments, ISP 206 stores the lines of pixels of the first image frame by storing a first number of lines of pixels that is less than a total number of lines of pixels of the first image frame, and ISP 206 stores the one or more lines of pixels of the second image frame by storing a second number of lines of pixels that is less than a total number of lines of pixels of the second image frame. For example, each of the image frames captured by image sensors 202A-202N may include a total of 2160 lines of pixels, whereas buffer 404 may be configured to store a maximum of 100 to 200 lines of pixels.

In some embodiments, ISP 206 stores the lines of pixels of the first image frame by storing the lines of pixels of the first image frame in buffer 404, while the one or more lines of pixels of the second image frame are exposed by the second image sensor (e.g., image sensor 202N). For example, as shown in FIG. 5, during the third time period (t2), ISP 206 may store, at 514, the lines of pixels of the first image frame in buffer 404 and process, at 516, such lines of pixels, while, at 522, image sensor 202N exposes the lines of pixels of the second image frame.

In some embodiments, the first display (e.g., display 216A) and second display (e.g., display 216N) are incorporated into a headset (e.g., device 100, as shown in FIG. 1), and the first display is configured to be viewed by a first eye of a user and the second display is configured to be viewed by a second eye of the user.

In 604, ISP 206 may provide the lines of pixels of the first image frame from buffer 404 to a first display (e.g., display 216A), while one or more lines of pixels of a second image frame are exposed by a second image sensor. For example, during the second time period (t1), ISP 206 may, at 510, provide the lines of pixels of the first image frame from buffer 404 or 406 to display 216A, while, at 512, a second image sensor (e.g., image sensor 202N) exposes lines of pixels of a second image frame.

In 606, ISP 206 may store the one or more lines of pixels of the second image frame in buffer 404 subsequent to the one or more lines of pixels of the second image frame being exposed by the second image sensor (e.g., image sensor 202N). For example, during the third time period (t2), image sensor 202N may, at 514, provide the exposed lines of pixels of the second image frame to buffer 402 for storage. At 516, ISP 206 may read the lines of pixels of the second image frame from buffer 402 and store the lines of pixels in buffer 404 for processing.

In some embodiments, ISP 206 may provide the one or more lines of pixels of the second image frame from buffer 404 to a second display (e.g., display 216N), while one or more lines of pixels of a third image frame are exposed by the first image sensor. For example, during the third time period (t2), ISP 206 may, at 520, provide the lines of pixels of the second image frame from buffer 404 or 406 to display 216N, while, at 522, image sensor 202A exposes lines of pixels of a third image frame to be displayed via display 216A.

In some embodiments, ISP 206 provides the lines of pixels of the first image frame from buffer 404 to the first display (e.g., display 216A) by providing the lines of pixels of the first image frame to the first display at a first time, and ISP 206 provides the one or more lines of pixels of the second image frame from buffer 404 to the second display (e.g., display 216N) by providing the one or more lines of pixels of the second image frame to the second display at a second time. Accordingly, the first image frame and the second image frame are not displayed by the first and second displays, respectively, at the same time.

In some embodiments, ISP 206 stores the one or more lines of pixels of the second image frame in buffer 404 by storing the one or more lines of pixels of the second image frame in buffer 404 in response to determining that a line of the lines of pixels of the first image frame being provided from buffer 404 to the first display (e.g., display 216A) is a final line of the lines of pixels of the first image frame.

Various aspects can be implemented, for example, using one or more computer systems, such as computer system 700 shown in FIG. 7. Computer system 700 can be any computer capable of performing the functions described herein, such as the functions of device 100 of FIGS. 1 and 2, image signal processor 206 of FIG. 3, system 400 (and the components thereof), as described with reference to FIG. 4, and the operations of FIGS. 5 and 6. Computer system 700 includes one or more processors (also called central processing units, or CPUs), such as a processor 704. Processor 704 is connected to a communication infrastructure 706 (e.g., a bus). Computer system 700 also includes user input/output device(s) 703, such as monitors, keyboards, and pointing devices, that communicate with communication infrastructure 706 through user input/output interface(s) 702. Computer system 700 also includes a main or primary memory 708, such as random access memory (RAM). Main memory 708 may include one or more levels of cache. Main memory 708 has stored therein control logic (e.g., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/or any other computer data storage device. Removable storage drive 714 reads from and/or writes to removable storage unit 718 in a well-known manner.

According to some aspects, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interface 720 may include a program cartridge and cartridge interface (e.g., such as that found in video game devices), a removable memory chip (e.g., an EPROM or PROM) and associated socket, a memory stick and USB port, a memory card and associated memory card slot, and/or any other removable storage unit and associated interface.

Computer system 700 may further include a communication or network interface 724. Communication interface 724 enables computer system 700 to communicate and interact with any combination of remote devices, remote networks, remote entities, etc. (individually and collectively referenced by reference number 728). For example, communication interface 724 may allow computer system 700 to communicate with remote devices 728 over communications path 726, which may be wired and/or wireless, and which may include any combination of LANs, WANs, the Internet, etc. Control logic and/or data may be transmitted to and from computer system 700 via communication path 726.

Image capture device(s) 730 may include one or more camera units configured to capture images, e.g., images which may be processed to generate enhanced versions of the captured images, e.g., based on this disclosure. Image capture device(s) 730 may include one or more lens assemblies 734, where each lens assembly has a separate focal length. For example, one lens assembly may have a shorter focal length relative to the focal length of another lens assembly. Each of lens assembly(ies) 734 may have a separate associated sensor element (e.g., sensor element(s) 732). Alternatively, lens assembly(ies) 734 may share common sensor element(s) 732. Sensor element(s) 732 may include image sensor(s) configured to convert light waves into electrical signals representing an image. Image capture device(s) 730 may capture still and/or video images. Output from image capture device(s) 730 may be processed, at least in part, by processor 704 and/or a dedicated image processing unit or image signal processor 736 incorporated within image capture device(s) 730. Image signal processor 736 may be configured to process captured images based on any suitable image processing algorithm. For example, image signal processor 736 can process raw data that represents the captured images into a suitable file format, such as Y'UV, YUV, YCbCr, YPbPr, or any other file format. As another example, image signal processor 736 may perform automatic white balance (AWB) and may resize images as needed. As an option, image signal processor 736 may be configured to compress the images into a suitable format by employing any available compression standard, such as JPEG or MPEG and their associated variants. Captured images may be stored in main memory 708 and/or secondary memory 710.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 700, main memory 708, secondary memory 710 and removable storage units 718 and 722, as well as tangible articles of manufacture embodying any combination of the foregoing. Such control logic, when executed by one or more data processing devices (e.g., computer system 700), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 7. In particular, aspects may operate with software, hardware, and/or operating system implementations other than those described herein.

The present disclosure includes references to “an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure can discuss potential advantages that can arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages can depend on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (e.g., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (e.g., having the potential to, being able to) and not in a mandatory sense (e.g., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers (1) x but not y, (2) y but not x, and (3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” and “given circuit”) refer to different instances of the feature. Additionally, the labels “first,” “second,” and “third” when applied to a feature do not imply any type of ordering (e.g., spatial, temporal, and logical), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

In this disclosure, different entities (which may variously be referred to as “units,” “circuits,” and “other components”) may be described or claimed as “configured” to perform one or more tasks or operations. This formulation—[entity] configured to [perform one or more tasks]—is used herein to refer to structure (e.g., something physical). More specifically, this formulation is used to indicate that this structure is arranged to perform the one or more tasks during operation. A structure can be said to be “configured to” perform some tasks even if the structure is not currently being operated. Thus, an entity described or recited as being “configured to” perform some tasks refers to something physical, such as a device, circuit, a system having a processor unit and a memory storing program instructions executable to implement the task. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, and latches), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, and memory management unit (MMU)). Such units also refer to circuits or circuitry.

The disclosed circuits/units/components and other elements illustrated in the drawings and described herein thus include hardware elements such as those described in the preceding paragraph. In many instances, the internal arrangement of hardware elements in a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description can be expressed in a fashion that may appear to be functional. But to those of skill in the art in this field, this HDL description is the manner that is used to transform the structure of a circuit, unit, or component to the next level of implementational detail. Such an HDL description may take the form of behavioral code (which may not be synthesizable), register transfer language (RTL) code (which, in contrast to behavioral code, may be synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, and inductors) and interconnect between the transistors and circuit elements. Some embodiments may implement multiple integrated circuits coupled to one another to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

Numerous variations and modifications will become apparent to those skilled in the art once the above disclosure is fully appreciated. It is intended that the following claims be interpreted to embrace all such variations and modifications.

1. A method, comprising:
storing, in a buffer, lines of pixels of a first image frame exposed by a first image sensor;
providing a processed version of the lines of pixels of the first image frame from the buffer to a first display device at a first time, while one or more lines of pixels of a second image frame are exposed by a second image sensor;
storing the one or more lines of pixels of the second image frame in the buffer subsequent to the one or more lines of pixels of the second image frame being exposed by the second image sensor; and
providing a processed version of the one or more lines of pixels of the second image frame from the buffer to a second display device that is different from the first display device at a second time subsequent to the first time.

2. The method of claim 1, wherein providing the processed version of the one or more lines of pixels of the second image frame from the buffer to the second display device comprises:
providing the processed version of the one or more lines of pixels of the second image frame from the buffer to the second display device, while one or more lines of pixels of a third image frame are exposed by the first image sensor.

3. (canceled)

4. The method of claim 1, wherein storing the lines of pixels of the first image frame comprises:
storing a first number of lines of pixels that is less than a total number of lines of pixels of the first image frame, and wherein storing the one or more lines of pixels of the second image frame comprises:
storing a second number of lines of pixels that is less than a total number of lines of pixels of the second image frame.

5. The method of claim 1, wherein storing the one or more lines of pixels of the second image frame in the buffer comprises:
in response to determining that a processed version of a line of the lines of pixels of the first image frame being provided from the buffer to the first display device is a final line of the processed version of the lines of pixels of the first image frame, storing the one or more lines of pixels of the second image frame in the buffer.

6. The method of claim 1, wherein storing the lines of pixels of the first image frame comprises:
storing the lines of pixels of the first image frame in the buffer, while the one or more lines of pixels of the second image frame are exposed by the second image sensor.

7. The method of claim 2, wherein the first display device and the second display device are incorporated into a virtual reality headset, and wherein the first display device is to be viewed by a first eye of a user and the second display device is to be viewed by a second eye of the user.

8. A system, comprising:
a memory to store a buffer; and
at least one processor to:
store lines of pixels of a first image frame exposed by a first image sensor in the buffer;
provide a processed version of the lines of pixels of the first image frame from the buffer to a first display device at a first time, while one or more lines of pixels of a second image frame are exposed by a second image sensor;
store the one or more lines of pixels of the second image frame in the buffer subsequent to the one or more lines of pixels of the second image frame being exposed by the second image sensor; and
provide a processed version of the one or more lines of pixels of the second image frame from the buffer to a second display device that is different from the first display device at a second time subsequent to the first time.

9. The system of claim 8, wherein, to provide the processed version of the one or more lines of pixels of the second image frame from the buffer to the second display device, the at least one processor to:
provide the processed version of the one or more lines of pixels of the second image frame from the buffer to the second display device, while one or more lines of pixels of a third image frame are exposed by the first image sensor.

10. (canceled)

11. The system of claim 8, wherein, to store the lines of pixels of the first image frame, the at least one processor to:
store a first number of lines of pixels that is less than a total number of lines of pixels of the first image frame, and wherein, to store the one or more lines of pixels of the second image frame, and
store a second number of lines of pixels that is less than a total number of lines of pixels of the second image frame.

12. The system of claim 8, wherein, to store the one or more lines of pixels of the second image frame in the buffer, the at least one processor to:
in response to a determination that a processed version of a line of the lines of pixels of the first image frame being provided from the buffer to the first display device is a final line of the processed version of the lines of pixels of the first image frame, store the one or more lines of pixels of the second image frame in the buffer.

13. The system of claim 8, wherein, to store the lines of pixels of the first image frame, the at least one processor to:
store the lines of pixels of the first image frame in the buffer, while the one or more lines of pixels of the second image frame are exposed by the second image sensor.

14. The system of claim 9, wherein the first display device and the second display device are incorporated into a virtual reality headset, the first display device to be viewed by a first eye of a user and the second display device to be viewed by a second eye of the user.

15. A non-transitory computer readable medium having instructions stored thereon that, when executed by at least one processor, cause the at least one processor to perform operations comprising:
storing, in a buffer, lines of pixels of a first image frame exposed by a first image sensor;
providing a processed version of the lines of pixels of the first image frame from the buffer to a first display device at a first time, while one or more lines of pixels of a second image frame are exposed by a second image sensor;
storing the one or more lines of pixels of the second image frame in the buffer subsequent to the one or more lines of pixels of the second image frame being exposed by the second image sensor; and
providing a processed version of the one or more lines of pixels of the second image frame from the buffer to a second display device that is different from the first display device at a second time subsequent to the first time.

16. The non-transitory computer readable medium of claim 15, wherein providing the processed version of the one or more lines of pixels of the second image frame from the buffer to the second display device comprises:
providing the processed version of the one or more lines of pixels of the second image frame from the buffer to the second display device, while one or more lines of pixels of a third image frame are exposed by the first image sensor.

17. (canceled)

18. The non-transitory computer readable medium of claim 15, wherein storing the lines of pixels of the first image frame comprises:
storing a first number of lines of pixels that is less than a total number of lines of pixels of the first image frame, and wherein storing the one or more lines of pixels of the second image frame comprises:
storing a second number of lines of pixels that is less than a total number of lines of pixels of the second image frame.

19. The non-transitory computer readable medium of claim 15, wherein storing the one or more lines of pixels of the second image frame in the buffer comprises:
in response to determining that a processed version of a line of the lines of pixels of the first image frame being provided from the buffer to the first display device is a final line of the processed version of the lines of pixels of the first image frame, storing the one or more lines of pixels of the second image frame in the buffer.

20. The non-transitory computer readable medium of claim 15, wherein storing the lines of pixels of the first image frame comprises:
storing the lines of pixels of the first image frame in the buffer, while the one or more lines of pixels of the second image frame are exposed by the second image sensor.

21. The method of claim 1, further comprising:
initiating the first image sensor at a third time for exposure of the first image frame; and
initiating the second image sensor at a fourth time for exposure of the second image frame, wherein the fourth time is subsequent to the third time.

22. The system of claim 8, wherein the at least one processor is to:
initiate the first image sensor at a third time for exposure of the first image frame by the first image sensor; and
initiate the second image sensor at a fourth time for exposure of the second image frame, wherein the fourth time is subsequent to the third time.

23. The non-transitory computer readable medium of claim 15, further comprising:
initiating the first image sensor at a third time for exposure of the first image frame; and
initiating the second image sensor at a fourth time for exposure of the second image frame, wherein the fourth time is subsequent to the third time.
